(19) United States
(12) Patent Application Publication
(10) Pub. No.: US 2017/0087600 A1
(43) Pub. Date: Mar. 30, 2017

(54) Kitchen Floor Mat Cleaning System

(71) Applicant: Shahe Leranian, Glendale, CA (US)

(72) Inventor: Shahe Leranian, Glendale, CA (US)

(21) Appl. No.: 14/867,830

(22) Filed: Sep. 28, 2015

(51) Int. Cl. B08B 3/02; B08B 3/14

(52) U.S. Cl. CPC B08B 3/026; B08B 3/14

(57) ABSTRACT

A floor mat cleaning system configured for cleaning an at least one floor mat is disclosed. In at least one embodiment, the system provides an enclosure sized for receiving the floor mat therewithin. A front wall of the enclosure defines an opening that allows access into the enclosure. A suspension mechanism is positioned within the enclosure and configured for allowing the floor mat to be selectively suspended therewithin. A washing assembly is engaged with the enclosure and configured for cleaning the suspended floor mat. A floor panel, front wall, rear wall and opposing side walls of the enclosure cooperate to define a basin configured for catching and retaining any debris or substances that might fall from the suspended floor mat while it is being cleaned.

### RELATED APPLICATIONS

Not applicable.

### BACKGROUND

The subject of this patent application relates generally to cleaning systems, and more particularly to a kitchen floor mat cleaning system configured for cleaning kitchen floor mats in a relatively quick, efficient and sanitary manner.

Applicant(s) hereby incorporate herein by reference any and all patents and published patent applications cited or referred to in this application.

By way of background, anti-fatigue floor mats are commonly used in commercial kitchens to help prevent slip-and-fall accidents and worker fatigue. Through use, these floor mats can become extremely dirty and unsanitary, not only due to foot traffic, but also because various types of foods, liquids and other substances tend to fall on them during use. As such, it is very important that these floor mats be cleaned and sanitized on a regular basis—preferably at the end of each day. Traditionally, these floor mats are typically cleaned by first carefully moving them to an outdoor area (such as an alleyway behind the building in which the kitchen is located), placing them on the ground, and then washing them off with a hose or pressure washer (sometimes with the assistance of cleaning solutions and a brush). Depending on the available drainage in the outdoor area, the removed contents of the floor mats are oftentimes simply left on the ground of the outdoor area rather than being picked up or washed away. In situations where the floor mats contain substances such as oil or grease, this traditional method of cleaning can create a significant mess over time. Additionally, where these floor mats are cleaned in the same location each time, this traditional method of cleaning increases the likelihood that the floor mats will be placed on the same unsanitary substances that were removed from the floor mats and left on the ground during a previous cleaning which, in turn, increases the chances of those unsanitary substances being brought back into the kitchen. In certain situations, a particular kitchen may not even have convenient access to an outdoor area for cleaning, such that the mats must be cleaned indoors somewhere—sometimes even in the kitchen—which is typically not as sanitary as cleaning the floor mats outdoors. Accordingly, there remains a need for a way to clean kitchen floor mats in a relatively quick, efficient and sanitary manner, regardless of location.

Aspects of the present invention fulfill these needs and provide further related advantages as described in the following summary.

### SUMMARY

Aspects of the present invention teach certain benefits in construction and use which give rise to the exemplary advantages described below.

The present invention solves the problems described above by providing a kitchen floor mat cleaning system configured for cleaning kitchen floor mats in a relatively quick, efficient and sanitary manner. In at least one embodiment, the system provides an enclosure sized for receiving the at least one floor mat therewithin, the enclosure providing a ceiling panel, a floor panel, a pair of opposing side walls, a rear wall and an opposing front wall. The front wall defines an opening that allows access into the enclosure. A suspension mechanism is positioned within the enclosure and configured for allowing the at least one floor mat to be selectively suspended within the enclosure. A washing assembly is engaged with the enclosure and configured for cleaning the at least one floor mat suspended within the enclosure. The floor panel, front wall, rear wall and side walls cooperate to define a basin within the enclosure, the basin configured for catching and retaining any debris or substances that might fall from the at least one suspended floor mat while it is being cleaned. During use, the system allows the at least one floor mat to be cleaned and subsequently hanged dry in a self-contained area, without having to move the at least one floor mat during the process.

Other features and advantages of aspects of the present invention will become apparent from the following more detailed description, taken in conjunction with the accompanying drawings, which illustrate, by way of example, the principles of aspects of the invention.

### BRIEF DESCRIPTION OF THE DRAWINGS

The accompanying drawings illustrate aspects of the present invention. In such drawings:

FIG. 1 is a perspective view of an exemplary floor mat cleaning system, in accordance with at least one embodiment;

FIG. 2 is a perspective view of an exemplary hanger rod of the exemplary floor mat cleaning system, in accordance with at least one embodiment;

FIG. 3 is a partial perspective view of an exemplary enclosure of the exemplary floor mat cleaning system, in accordance with at least one embodiment;

FIG. 4 is a perspective view of a further exemplary enclosure of the exemplary floor mat cleaning system, in accordance with at least one embodiment;

FIG. 5 is a perspective view of the exemplary floor mat cleaning system in use, in accordance with at least one embodiment;

FIG. 6 is a perspective view of a still further exemplary enclosure of the exemplary floor mat cleaning system, in accordance with at least one embodiment; and

FIG. 7 is a partial perspective view of a still further exemplary enclosure of the exemplary floor mat cleaning system, in accordance with at least one embodiment.

The above described drawing figures illustrate aspects of the invention in at least one of its exemplary embodiments, which are further defined in detail in the following description. Features, elements, and aspects of the invention that are referenced by the same numerals in different figures represent the same, equivalent, or similar features, elements, or aspects, in accordance with one or more embodiments.

### DETAILED DESCRIPTION

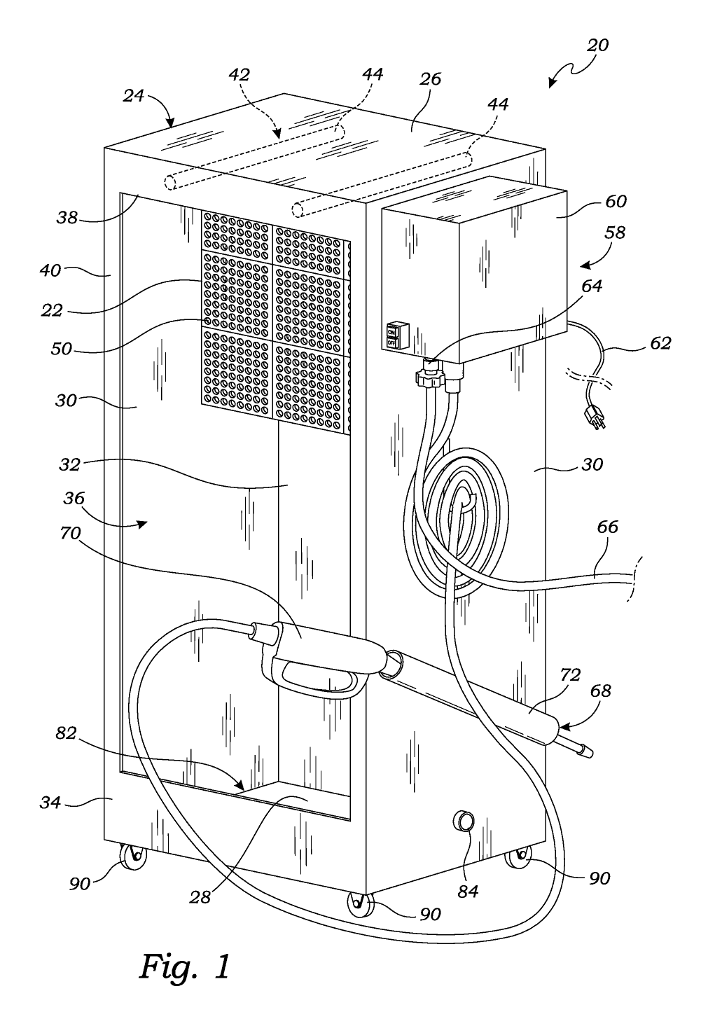

Turning now to FIG. 1, there is shown a perspective view of an exemplary floor mat cleaning system 20 configured for cleaning an at least one kitchen floor mat 22 in a relatively quick, efficient and sanitary manner. At the outset, it should be noted that while the at least one floor mat 22 is referred to as being a “kitchen floor mat,” this merely due to the fact that such anti-fatigue floor mats are often used in commercial kitchen environments. Accordingly, in at least one embodiment, the system 20 is capable of cleaning any such anti-fatigue floor mats, regardless of whether such mats are used in a commercial kitchen environment or any other environment, commercial or otherwise. Thus, the present invention should not be read as being so limited.

With continued reference to FIG. 1, in at least one embodiment, the system 20 provides an enclosure 24 sized for receiving at least one floor mat 22 therewithin. In at least one embodiment, the enclosure 24 provides a ceiling panel 26, a floor panel 28, a pair of opposing side walls 30 each extending between the ceiling panel 26 and floor panel 28, as well as a rear wall 32 and an opposing front wall 34 each extending between the ceiling panel 26 and floor panel 28. It should be noted that while the enclosure 24 is depicted in the drawings as being substantially rectangular in shape, in further embodiments, the enclosure 24 may take on any other size, shape or dimensions now known or later conceived, and may similarly be of any multi-plane-sided construction, so long as the enclosure 24 is substantially capable of carrying out the functionality described herein. In at least one embodiment, the front wall 34 defines an opening 36 that allows access into the enclosure 24. In at least one such embodiment, a perimeter edge 38 of the opening 36 is spaced a distance from each of the ceiling panel 26, floor panel 28 and side walls 30, thereby forming a lip 40 about the opening 36. However, in at least one alternate embodiment, the opening 36 may be flush with one or more of the ceiling panel 26, floor panel 28 and side walls 30. In at least one further alternate embodiment, the front wall 34 is omitted altogether.

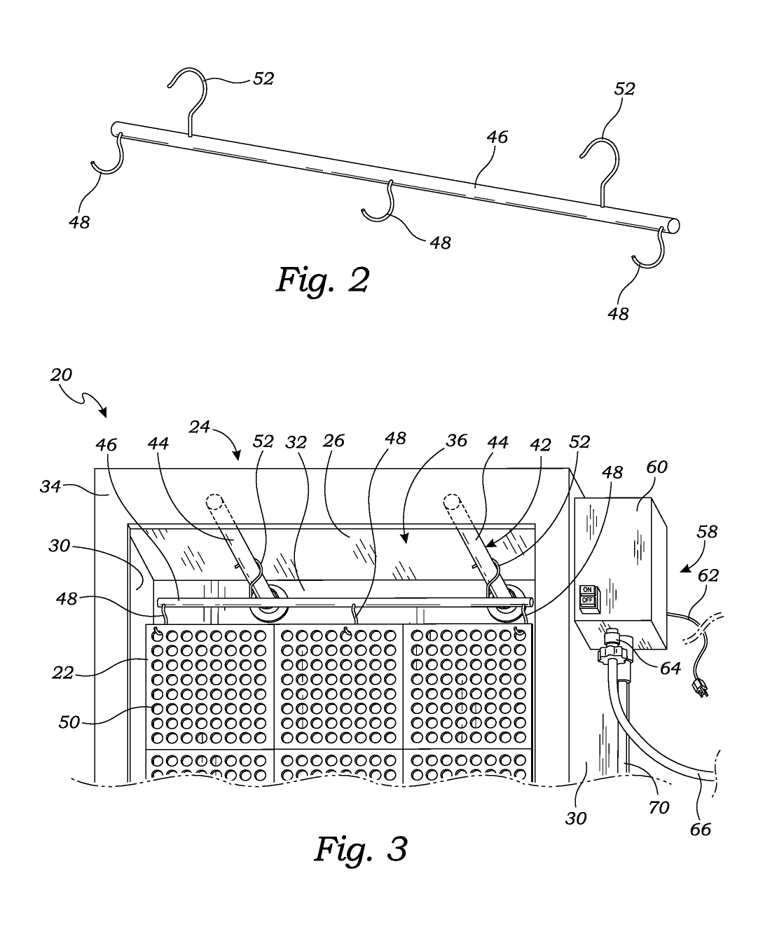

In at least one embodiment, as best shown in FIGS. 1-3, the enclosure 24 provides a suspension mechanism 42 positioned within the enclosure 24 and configured for allowing the at least one floor mat 22 to be selectively suspended within the enclosure 24 during use. Not only does suspending the at least one floor mat 22 make the process of washing it relatively easier, but it also allows the at least one floor mat 22 to hang dry (without having to remove it from the enclosure 24) after the washing has been completed. In at least one embodiment, the suspension mechanism 42 provides an at least one elongate suspension bar 44 mounted proximal to the ceiling panel 26. In at least one such embodiment, the at least one suspension bar 44 extends between the rear wall 32 and the front wall 34. In at least one alternate embodiment, the at least one suspension bar 44 extends between the opposing side walls 30. As illustrated in FIGS. 1-3, in at least one embodiment, the enclosure 24 provides a pair of spaced apart, substantially parallel suspension bars 44. In at least one embodiment, the at least one suspension bar 44 is configured for removably supporting an at least one mat hanger 46, the at least one mat hanger 46 configured for removably supporting the at least one floor mat 22. In a bit more detail, in at least one such embodiment, the at least one mat hanger 46 is an elongate structure that provides an at least one mat hook 48 positioned and configured for removably engaging a mat aperture 50 provided by the at least one floor mat 22—the at least one floor mat 22 providing a plurality of spaced apart mat apertures 50 in at least one embodiment. Additionally, in at least one such embodiment, the at least one mat hanger 46 further provides an at least one suspension hook 52 positioned and configured for removably engaging the at least one suspension bar 44. In at least one embodiment, the at least one mat hook 48 is positioned on the mat hanger 46 in a substantially opposing direction relative to the at least one suspension hook 52, which allows the at least one floor mat 22 to be suspended in a position substantially below that of the at least one suspension bar 44, as illustrated best in FIG. 1. It should be noted that the particular size, shape and dimensions of the at least one mat hanger 46 is at least partially dependent on both the number and arrangement of the at least one suspension bar 44, as well as the number and arrangement of the at least one mat aperture 50. Accordingly, the particular embodiment of the mat hanger 46 depicted in the drawings is merely exemplary and is being shown for illustrative purposes only. In further embodiments, the at least one mat hanger 46, along with the at least one suspension bar 44, may take on any other size, shape or dimensions now known or later conceived, and may similarly be of any multi-plane-sided construction. Thus, the present invention should not be read as being so limited. In at least one still further embodiment, the at least one mat hanger 46 may be omitted altogether, with the at least one mat hook 48 being integral with the at least one suspension bar 44 instead.

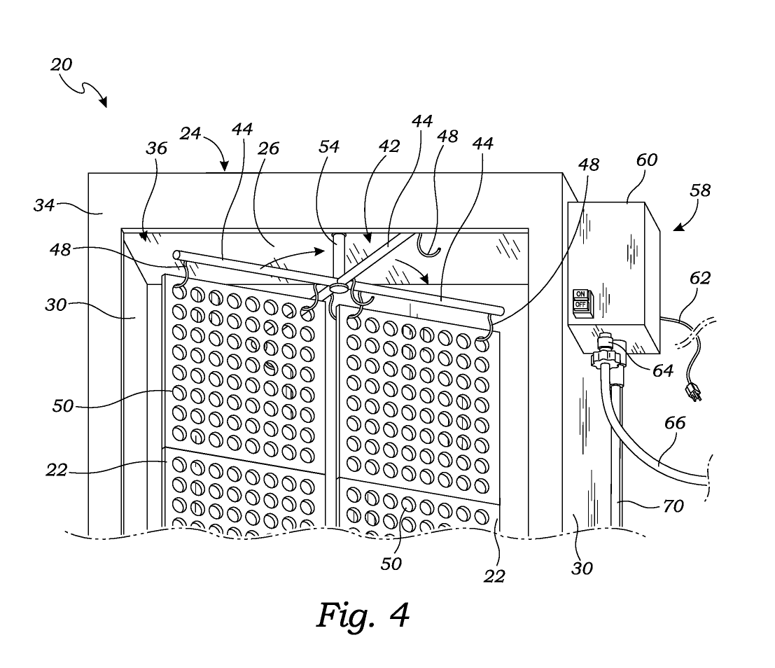

In at least one alternate embodiment, as shown in FIG. 4, the suspension mechanism 42 provides a center rod 54 secured to the ceiling panel 26 of the enclosure 24 and extending downwardly therefrom in a substantially perpendicular direction relative to the ceiling panel 26. The center rod 54 provides at least one suspension bar 44 extending substantially perpendicularly therefrom and configured for rotating about a substantially vertical axis 56 defined by the center rod 54, which makes it relatively easier to clean multiple floor mats 22 at once. In at least one such embodiment, the at least one suspension bar 44 rotates about the center rod 54. In at least one alternate embodiment, the center rod 54 itself is capable of rotating relative to the ceiling panel 26. In at least one embodiment, as illustrated in FIG. 4, the center rod 54 provides a plurality of spaced apart suspension bars 44 arranged radially about the center rod 54. In at least one embodiment, the at least one suspension bar 44 is configured for removably supporting at least one mat hanger 46, the at least one mat hanger 46 configured for removably supporting the at least one floor mat 22. In at least one alternate embodiment, as illustrated in FIG. 4, the at least one suspension bar provides at least one mat hook 48 positioned and configured for removably engaging the at least one mat aperture 50 of the at least one floor mat 22. In at least one further alternate embodiment, the center rod 54 may be secured to the floor panel 28 of the enclosure 24 and extend upwardly therefrom in a substantially perpendicular direction relative to the floor panel 28. In still further alternate embodiments, the suspension mechanism 42 may incorporate any other structures, mechanisms, or combinations thereof, now known or later developed, capable of allowing the at least one floor mat 22 to be selectively suspended within the enclosure 24 during use. In at least one embodiment, the suspension mechanism 42 further provides a motor (not shown) positioned and configured for causing the at least one suspension bar 44 to automatically rotate about the vertical axis 56 defined by the center rod 54.

In at least one embodiment, the suspension mechanism 42 further provides an at least one mat connector (not shown) comprising a pair of opposing mat hooks 48 and configured for suspending a further floor mat 22 from a first floor mat 22 that is suspended within the enclosure 24. In a bit more detail, in at least one such embodiment, a first one of the opposing mat hooks 48 is removably engaged with one of the mat apertures 50 of a first floor mat 22 that is suspended within the enclosure 24 via the suspension mechanism 42, while a second one of the opposing mat hooks 48 is removably engaged with one of the mat apertures 50 of a further floor mat 22, such that the further floor mat 22 may be suspended from the first floor mat 22. In this way, the at least one mat connector allows for relatively more floor mats 22 to be suspended within the enclosure 24 at one time.

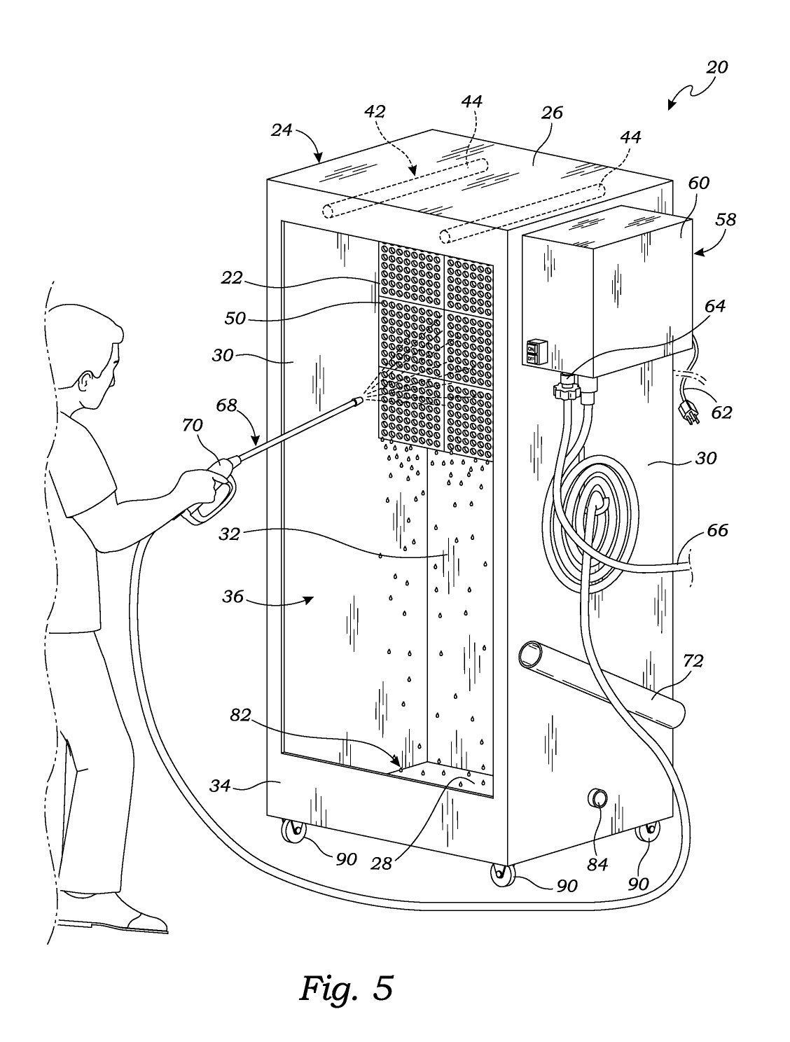

Referring again to FIG. 1, and as further illustrated in FIG. 5, in at least one embodiment, the system 20 provides a washing assembly 58 engaged with the enclosure 24 and configured for cleaning the at least one floor mat 22 suspended within the enclosure 24. In at least one embodiment, the washing assembly 58 provides a pump (not shown) positioned within a housing 60 that is secured to the enclosure 24. Additionally, in at least one embodiment, the washing assembly 58 provides a power supply (not shown) positioned within the housing 60, along with a length of electrical wiring 62 interconnecting the power supply and the pump and configured for being connected to an external electrical source (such as an electrical outlet, for example) for selectively powering the pump. In still further embodiments, the power supply is electrically connected to any other components of the system 20 that require electrical power. In at least one embodiment, the washing assembly 58 further provides a water inlet connector 64 in fluid communication with the pump and configured for allowing the pump to be selectively connected to an external water source via a water inlet line 66 such as a hose, for example. In at least one embodiment, the washing assembly 58 further provides an at least one spray mechanism 68 in fluid communication with the pump and configured for selectively spraying the at least one floor mat 22 suspended within the enclosure 24. In at least one embodiment, the at least one spray mechanism 68 is a spray hose 70 such as a pressure nozzle or pressure washing gun, for example. In at least one such embodiment, the enclosure 24 provides a hose mount 72 positioned and configured for storing the spray hose 70 when not in use. In at least one embodiment, the washing mechanism 58 provides an at least one water tank (not shown) in fluid communication with the pump and secured to the enclosure 24; the at least one water tank configured for storing a volume of water and optionally providing said water to the pump, which can be beneficial in contexts where an external water source is not available. Additionally, in at least one embodiment, the washing mechanism 58 provides an at least one solution tank (not shown) in fluid communication with the pump and secured to the enclosure 24; the at least one solution tank configured for storing a volume of a cleaning solution (or a mixture of solutions) and optionally providing said cleaning solution to the pump, which may be mixed with the water and sprayed onto the at least one floor mat 22 suspended within the enclosure 24.

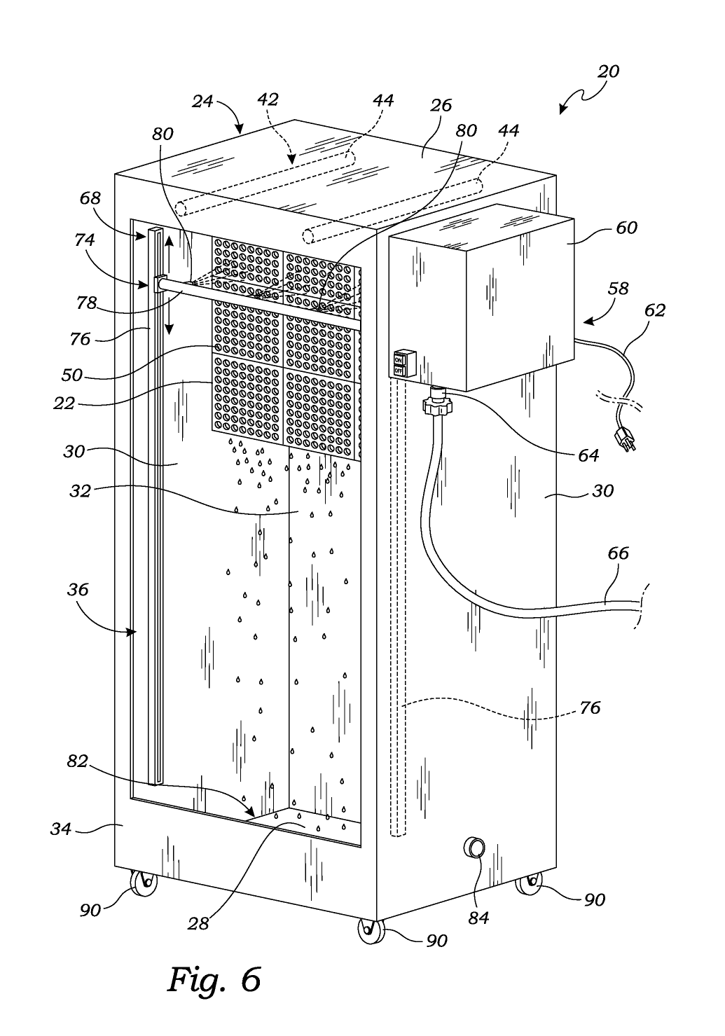

In at least one alternate embodiment, as shown in FIG. 6, the at least one spray mechanism 68 is a motorized spray assembly 74 positioned within the enclosure 24 and configured for automatically washing the at least one floor mat 22 suspended within the enclosure 24. In at least one such embodiment, the spray assembly 74 provides a pair of substantially vertically oriented tracks 76 mounted to the opposing side walls 30 of the enclosure 24. Additionally, the spray assembly 74 provides an at least one nozzle array 78 configured for riding on the tracks 76 and having an at least one spray nozzle 80 in fluid communication with the pump. The spray assembly 74 further provides an at least one motor (not shown) positioned and configured for automatically moving the at least one nozzle array 78 along the tracks 76. In at least one further alternate embodiment, the spray mechanism 68 is at least one spray nozzle 80 statically mounted within the enclosure 24. In still further embodiments, the at least one spray mechanism 68 may be any combination of such mechanisms (i.e., spray hose 70, spray assembly 74, spray nozzles 80, etc.). In still further embodiments, any other mechanism (or combination of mechanisms)—now known or later developed—capable of operating in conjunction with the enclosure 24 for cleaning the at least one floor mat 22 may be substituted.

Referring again to FIG. 1, in at least one embodiment, the floor panel 28, front wall 34, rear wall 32 and side walls 30 cooperate to define a basin 82 within the enclosure 24, the basin 82 being configured for catching and retaining any debris or substances (including water or other fluids) that might fall from the at least one suspended floor mat 22 while it is being washed. Additionally, the basin 82 provides an at least one drain hole 84 configured for selectively draining the contents of the basin 82. In at least one such embodiment, the at least one drain hole 84 is positioned within at least one of the front wall 34, rear wall 32, or one of the side walls 30, such that the drain hole 84 is positioned a distance above the floor panel 28. In at least one alternate embodiment, the at least one drain hole 84 is positioned within the floor panel 28.

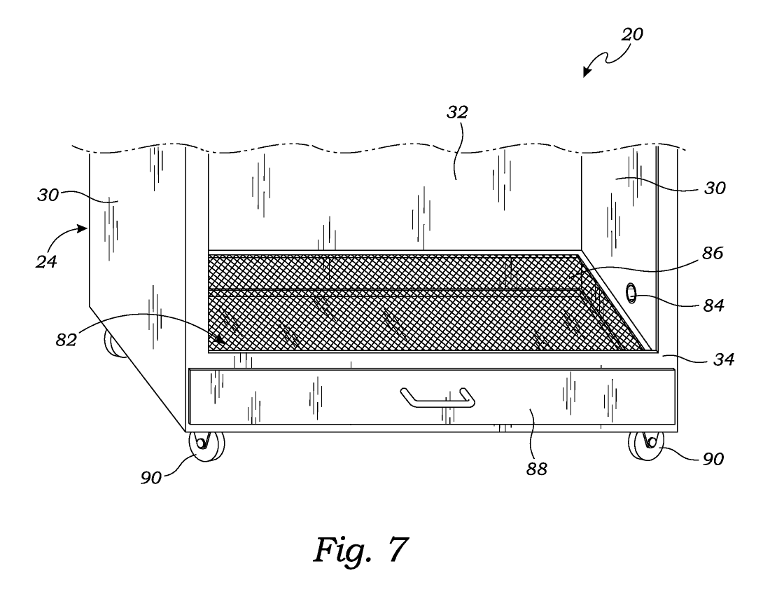

In at least one embodiment, as shown in FIG. 7, the enclosure 24 provides an at least one filter 86 positioned a distance above the floor panel 28 and configured filtering debris that might fall into the basin 82, thereby facilitating in the separation and removal of the debris before the remaining liquid contents of the basin 82 are drained. Additionally, in at least one embodiment, the filter 86 is configured as a drawer 88 that is slidably engaged with the enclosure 24, thereby further assisting in the removal of any debris. In at least one further embodiment, the filter 86 provides an at least one handle (not shown) so that it may be selectively lifted out of the basin 82 for cleaning. In at least one still further embodiment, the basin 82 provides a grease trap (not shown) for collecting any grease or oil (along with debris) that might fall from the at least one suspended floor mat 22 while it is being washed. As such, in at least one embodiment, the system 20 allows for the separation and removal of any such materials before the liquids are emptied from the basin 82, thus preventing such materials from being left on the ground or allowed to enter a drainage system where such materials could potentially cause damage over time.

Referring again to FIG. 1, in at least one embodiment, the enclosure 24 provides a plurality of casters 90 positioned on the floor panel 28 and configured for allowing the system 20 to be more easily transported. Additionally, where the system 20 is moved between a storage location (when the system 20 is not in use), such as a kitchen for example, and a cleaning location (when the system 20 is in use), such as an outdoor area for example, the system 20 allows for the suspended floor mats 22 to not only be cleaned within the enclosure 24, but it also allows for the floor mats 22 to hang dry (without having to remove them from the enclosure 24) after the washing has been completed, such that the floor mats 22 may continue hang drying within the enclosure 24 even after the system 20 is moved back to the storage location. Accordingly then, during use, the system 20 allows the at least one floor mat 22 to be cleaned and subsequently hanged dry in a self-contained area (i.e., the enclosure 24), without having to move the at least one floor mat 22 during the process and without creating a mess in the surrounding area.

Aspects of the present specification may also be described as follows:

1. A floor mat cleaning system configured for cleaning an at least one floor mat, the system comprising: an enclosure sized for receiving the at least one floor mat therewithin, the enclosure providing a ceiling panel, a floor panel, a pair of opposing side walls, a rear wall and an opposing front wall; the front wall defining an opening that allows access into the enclosure; a suspension mechanism positioned within the enclosure and configured for allowing the at least one floor mat to be selectively suspended within the enclosure; a washing assembly engaged with the enclosure and configured for cleaning the at least one floor mat suspended within the enclosure; and the floor panel, front wall, rear wall and side walls cooperating to define a basin within the enclosure, the basin configured for catching and retaining any debris or substances that might fall from the at least one suspended floor mat while it is being cleaned; whereby, during use, the system allows the at least one floor mat to be cleaned and subsequently hanged dry in a self-contained area, without having to move the at least one floor mat during the process.

2. The floor mat cleaning system according to embodiment 1, wherein a perimeter of the opening is spaced a distance from each of the ceiling panel, floor panel and side walls, thereby forming a lip about the opening.

3. The floor mat cleaning system according to embodiments 1-2, wherein the suspension mechanism comprises an at least one elongate suspension bar mounted proximal to the ceiling panel of the enclosure.

4. The floor mat cleaning system according to embodiments 1-3, wherein the at least one suspension bar extends between the rear wall and the front wall of the enclosure.

5. The floor mat cleaning system according to embodiments 1-4, wherein the at least one suspension bar extends between the opposing side walls of the enclosure.

6. The floor mat cleaning system according to embodiments 1-5, wherein the suspension mechanism further comprises an at least one elongate mat hanger configured for removably supporting the at least one floor mat, the at least one mat hanger capable of being removably engaged with the at least one suspension bar, thereby allowing the at least one floor mat to be selectively suspended within the enclosure.

7. The floor mat cleaning system according to embodiments 1-6, wherein the at least one mat hanger provides: an at least one mat hook positioned and configured for removably engaging a mat aperture provided by the at least one floor mat; and an at least one suspension hook positioned and configured for removably engaging the at least one suspension bar.

8. The floor mat cleaning system according to embodiments 1-7, wherein the at least one mat hook is positioned on the at least one mat hanger in a substantially opposing direction relative to the at least one suspension hook.

9. The floor mat cleaning system according to embodiments 1-8, wherein the at least one suspension bar provides an at least one mat hook positioned and configured for removably engaging a mat aperture provided by the at least one floor mat, thereby allowing the at least one floor mat to be selectively suspended within the enclosure.

10. The floor mat cleaning system according to embodiments 1-9, wherein the suspension mechanism comprises: a center rod secured to the ceiling panel of the enclosure and extending downwardly therefrom in a substantially perpendicular direction relative to the ceiling panel; and the center rod providing an at least one suspension bar extending substantially perpendicularly therefrom and configured for rotating about a substantially vertical axis defined by the center rod.

11. The floor mat cleaning system according to embodiments 1-10, wherein the suspension mechanism further comprises an at least one elongate mat hanger configured for removably supporting the at least one floor mat, the at least one mat hanger capable of being removably engaged with the at least one suspension bar, thereby allowing the at least one floor mat to be selectively suspended within the enclosure.

12. The floor mat cleaning system according to embodiments 1-11, wherein the at least one mat hanger provides: an at least one mat hook positioned and configured for removably engaging a mat aperture provided by the at least one floor mat; and an at least one suspension hook positioned and configured for removably engaging the at least one suspension bar.

13. The floor mat cleaning system according to embodiments 1-12, wherein the at least one mat hook is positioned on the at least one mat hanger in a substantially opposing direction relative to the at least one suspension hook.

14. The floor mat cleaning system according to embodiments 1-13, wherein the at least one suspension bar provides an at least one mat hook positioned and configured for removably engaging a mat aperture provided by the at least one floor mat, thereby allowing the at least one floor mat to be selectively suspended within the enclosure.

15. The floor mat cleaning system according to embodiments 1-14, wherein the center rod provides a plurality of spaced apart suspension bars arranged radially about the center rod.

16. The floor mat cleaning system according to embodiments 1-15, wherein the suspension mechanism further comprises a motor positioned and configured for causing the at least one suspension bar to automatically rotate about the vertical axis defined by the center rod.

17. The floor mat cleaning system according to embodiments 1-16, wherein the washing assembly comprises: a pump positioned within a housing that is secured to the enclosure; a water inlet connector in fluid communication with the pump and configured for allowing the pump to be selectively connected to an external water source; and an at least one spray mechanism in fluid communication with the pump and configured for selectively spraying the at least one floor mat suspended within the enclosure.

18. The floor mat cleaning system according to embodiments 1-17, wherein the at least one spray mechanism is a spray hose.

19. The floor mat cleaning system according to embodiments 1-18, wherein the washing assembly further comprises a hose mount positioned and configured for storing the spray hose when not in use.

20. The floor mat cleaning system according to embodiments 1-19, wherein the at least one spray mechanism is a motorized spray assembly positioned within the enclosure and configured for automatically washing the at least one floor mat suspended within the enclosure.

21. The floor mat cleaning system according to embodiments 1-20, wherein the spray assembly comprises: a pair of substantially vertically oriented tracks mounted to the opposing side walls of the enclosure; an at least one nozzle array configured for riding on the tracks and having an at least one spray nozzle in fluid communication with the pump; and an at least one motor positioned and configured for automatically moving the at least one nozzle array along the tracks.

22. The floor mat cleaning system according to embodiments 1-21, wherein the at least one spray mechanism is an at least one spray nozzle statically mounted within the enclosure.

23. The floor mat cleaning system according to embodiments 1-22, wherein the washing mechanism further comprises an at least one water tank in fluid communication with the pump and secured to the enclosure, the at least one water tank configured for storing a volume of water and providing said water to the pump.

24. The floor mat cleaning system according to embodiments 1-23, wherein the washing mechanism further comprises an at least one solution tank in fluid communication with the pump and secured to the enclosure, the at least one solution tank configured for storing a volume of a cleaning solution and providing said cleaning solution to the pump.

25. The floor mat cleaning system according to embodiments 1-24, wherein the basin provides an at least one drain hole configured for selectively draining the contents of the basin.

26. The floor mat cleaning system according to embodiments 1-25, wherein the at least one drain hole is positioned within at least one of the front wall, rear wall, or one of the side walls, such that the at least one drain hole is positioned a distance above the floor panel.

27. The floor mat cleaning system according to embodiments 1-26, wherein the at least one drain hole is positioned within the floor panel.

28. The floor mat cleaning system according to embodiments 1-27, further comprising an at least one filter positioned a distance above the floor panel and configured filtering debris that falls into the basin.

29. The floor mat cleaning system according to embodiments 1-28, wherein the filter is configured as a drawer that is slidably engaged with the enclosure.

30. The floor mat cleaning system according to embodiments 1-29, wherein the basin provides a grease trap for collecting any grease or oil that might fall from the at least one suspended floor mat while it is being cleaned.

31. The floor mat cleaning system according to embodiments 1-30, further comprising a plurality of casters positioned on the floor panel of the enclosure and configured for assisting in the transport of the system.

32. A floor mat cleaning system configured for cleaning an at least one floor mat, the system comprising: an enclosure sized for receiving the at least one floor mat therewithin, the enclosure providing a ceiling panel, a floor panel, a pair of opposing side walls, a rear wall and an opposing front wall; the front wall defining an opening that allows access into the enclosure; an at least one elongate suspension bar mounted proximal to the ceiling panel of the enclosure; an at least one elongate mat hanger configured for removably supporting the at least one floor mat, the at least one mat hanger capable of being removably engaged with the at least one suspension bar, thereby allowing the at least one floor mat to be selectively suspended within the enclosure; a washing assembly engaged with the enclosure and configured for cleaning the at least one floor mat suspended within the enclosure; and the floor panel, front wall, rear wall and side walls cooperating to define a basin within the enclosure, the basin configured for catching and retaining any debris or substances that might fall from the at least one suspended floor mat while it is being cleaned; whereby, during use, the system allows the at least one floor mat to be cleaned and subsequently hanged dry in a self-contained area, without having to move the at least one floor mat during the process.

33. A floor mat cleaning system configured for cleaning an at least one floor mat, the system comprising: an enclosure sized for receiving the at least one floor mat therewithin, the enclosure providing a ceiling panel, a floor panel, a pair of opposing side walls, a rear wall and an opposing front wall; the front wall defining an opening that allows access into the enclosure; a suspension mechanism positioned within the enclosure and configured for allowing the at least one floor mat to be selectively suspended within the enclosure; a pump positioned within a housing that is secured to the enclosure; a water inlet connector in fluid communication with the pump and configured for allowing the pump to be selectively connected to an external water source; an at least one spray mechanism in fluid communication with the pump and configured for selectively spraying the at least one floor mat suspended within the enclosure; and the floor panel, front wall, rear wall and side walls cooperating to define a basin within the enclosure, the basin configured for catching and retaining any debris or substances that might fall from the at least one suspended floor mat while it is being cleaned; whereby, during use, the system allows the at least one floor mat to be cleaned and subsequently hanged dry in a self-contained area, without having to move the at least one floor mat during the process.

In closing, regarding the exemplary embodiments of the present invention as shown and described herein, it will be appreciated that a kitchen floor mat cleaning system is disclosed and configured for cleaning kitchen floor mats in a relatively quick and efficient manner. Because the principles of the invention may be practiced in a number of configurations beyond those shown and described, it is to be understood that the invention is not in any way limited by the exemplary embodiments, but is generally directed to a kitchen floor mat cleaning system and is able to take numerous forms to do so without departing from the spirit and scope of the invention. It will also be appreciated by those skilled in the art that the present invention is not limited to the particular geometries and materials of construction disclosed, but may instead entail other functionally comparable structures or materials, now known or later developed, without departing from the spirit and scope of the invention.

Certain embodiments of the present invention are described herein, including the best mode known to the inventor(s) for carrying out the invention. Of course, variations on these described embodiments will become apparent to those of ordinary skill in the art upon reading the foregoing description. The inventor(s) expect skilled artisans to employ such variations as appropriate, and the inventor(s) intend for the present invention to be practiced otherwise than specifically described herein. Accordingly, this invention includes all modifications and equivalents of the subject matter recited in the claims appended hereto as permitted by applicable law. Moreover, any combination of the above-described embodiments in all possible variations thereof is encompassed by the invention unless otherwise indicated herein or otherwise clearly contradicted by context.

Groupings of alternative embodiments, elements, or steps of the present invention are not to be construed as limitations. Each group member may be referred to and claimed individually or in any combination with other group members disclosed herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Unless otherwise indicated, all numbers expressing a characteristic, item, quantity, parameter, property, term, and so forth used in the present specification and claims are to be understood as being modified in all instances by the term “about.” As used herein, the term “about” means that the characteristic, item, quantity, parameter, property, or term so qualified encompasses a range of plus or minus ten percent above and below the value of the stated characteristic, item, quantity, parameter, property, or term. Accordingly, unless indicated to the contrary, the numerical parameters set forth in the specification and attached claims are approximations that may vary. At the very least, and not as an attempt to limit the application of the doctrine of equivalents to the scope of the claims, each numerical indication should at least be construed in light of the number of reported significant digits and by applying ordinary rounding techniques. Notwithstanding that the numerical ranges and values setting forth the broad scope of the invention are approximations, the numerical ranges and values set forth in the specific examples are reported as precisely as possible. Any numerical range or value, however, inherently contains certain errors necessarily resulting from the standard deviation found in their respective testing measurements. Recitation of numerical ranges of values herein is merely intended to serve as a shorthand method of referring individually to each separate numerical value falling within the range. Unless otherwise indicated herein, each individual value of a numerical range is incorporated into the present specification as if it were individually recited herein.

Use of the terms “may” or “can” in reference to an embodiment or aspect of an embodiment also carries with it the alternative meaning of “may not” or “cannot.” As such, if the present specification discloses that an embodiment or an aspect of an embodiment may be or can be included as part of the inventive subject matter, then the negative limitation or exclusionary proviso is also explicitly meant, meaning that an embodiment or an aspect of an embodiment may not be or cannot be included as part of the inventive subject matter. In a similar manner, use of the term “optionally” in reference to an embodiment or aspect of an embodiment means that such embodiment or aspect of the embodiment may be included as part of the inventive subject matter or may not be included as part of the inventive subject matter. Whether such a negative limitation or exclusionary proviso applies will be based on whether the negative limitation or exclusionary proviso is recited in the claimed subject matter.

The terms “a,” “an,” “the” and similar references used in the context of describing the present invention (especially in the context of the following claims) are to be construed to cover both the singular and the plural, unless otherwise indicated herein or clearly contradicted by context. Further, ordinal indicators—such as “first,” “second,” “third,” etc. —for identified elements are used to distinguish between the elements, and do not indicate or imply a required or limited number of such elements, and do not indicate a particular position or order of such elements unless otherwise specifically stated. All methods described herein can be performed in any suitable order unless otherwise indicated herein or otherwise clearly contradicted by context. The use of any and all examples, or exemplary language (e.g., “such as”) provided herein is intended merely to better illuminate the present invention and does not pose a limitation on the scope of the invention otherwise claimed. No language in the present specification should be construed as indicating any non-claimed element essential to the practice of the invention.

Specific embodiments disclosed herein may be further limited in the claims using consisting of or consisting essentially of language. When used in the claims, whether as filed or added per amendment, the transition term “consisting of” excludes any element, step, or ingredient not specified in the claims. The transition term “consisting essentially of” limits the scope of a claim to the specified materials or steps and those that do not materially affect the basic and novel characteristic(s). Embodiments of the present invention so claimed are inherently or expressly described and enabled herein.

All patents, patent publications, and other publications referenced and identified in the present specification are individually and expressly incorporated herein by reference in their entirety for the purpose of describing and disclosing, for example, the compositions and methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

While aspects of the invention have been described with reference to at least one exemplary embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

What is claimed is:

1. A floor mat cleaning system configured for cleaning an at least one floor mat, the system comprising:
an enclosure sized for receiving the at least one floor mat therewithin, the enclosure providing a ceiling panel, a floor panel, a pair of opposing side walls, a rear wall and an opposing front wall;
the front wall defining an opening that allows access into the enclosure;
a suspension mechanism positioned within the enclosure and configured for allowing the at least one floor mat to be selectively suspended within the enclosure;
a washing assembly engaged with the enclosure and configured for cleaning the at least one floor mat suspended within the enclosure; and
the floor panel, front wall, rear wall and side walls cooperating to define a basin within the enclosure, the basin configured for catching and retaining any debris or substances that might fall from the at least one suspended floor mat while it is being cleaned;
whereby, during use, the system allows the at least one floor mat to be cleaned and subsequently hanged dry in a self-contained area, without having to move the at least one floor mat during the process.

2. The floor mat cleaning system of claim 1, wherein the suspension mechanism comprises an at least one elongate suspension bar mounted proximal to the ceiling panel of the enclosure.

3. The floor mat cleaning system of claim 2, wherein the suspension mechanism further comprises an at least one elongate mat hanger configured for removably supporting the at least one floor mat, the at least one mat hanger capable of being removably engaged with the at least one suspension bar, thereby allowing the at least one floor mat to be selectively suspended within the enclosure.

4. The floor mat cleaning system of claim 3, wherein the at least one mat hanger provides:
an at least one mat hook positioned and configured for removably engaging a mat aperture provided by the at least one floor mat; and
an at least one suspension hook positioned and configured for removably engaging the at least one suspension bar.

5. The floor mat cleaning system of claim 2, wherein the at least one suspension bar provides an at least one mat hook positioned and configured for removably engaging a mat aperture provided by the at least one floor mat, thereby allowing the at least one floor mat to be selectively suspended within the enclosure.

6. The floor mat cleaning system of claim 1, wherein the suspension mechanism comprises:
a center rod secured to the ceiling panel of the enclosure and extending downwardly therefrom in a substantially perpendicular direction relative to the ceiling panel; and
the center rod providing an at least one suspension bar extending substantially perpendicularly therefrom and configured for rotating about a substantially vertical axis defined by the center rod.

7. The floor mat cleaning system of claim 6, wherein the suspension mechanism further comprises an at least one elongate mat hanger configured for removably supporting the at least one floor mat, the at least one mat hanger capable of being removably engaged with the at least one suspension bar, thereby allowing the at least one floor mat to be selectively suspended within the enclosure.

8. The floor mat cleaning system of claim 7, wherein the at least one mat hanger provides:
an at least one mat hook positioned and configured for removably engaging a mat aperture provided by the at least one floor mat; and
an at least one suspension hook positioned and configured for removably engaging the at least one suspension bar.

9. The floor mat cleaning system of claim 6, wherein the at least one suspension bar provides an at least one mat hook positioned and configured for removably engaging a mat aperture provided by the at least one floor mat, thereby allowing the at least one floor mat to be selectively suspended within the enclosure.

10. The floor mat cleaning system of claim 1, wherein the washing assembly comprises:
a pump positioned within a housing that is secured to the enclosure;
a water inlet connector in fluid communication with the pump and configured for allowing the pump to be selectively connected to an external water source; and
an at least one spray mechanism in fluid communication with the pump and configured for selectively spraying the at least one floor mat suspended within the enclosure.

11. The floor mat cleaning system of claim 10, wherein the at least one spray mechanism is a spray hose.

12. The floor mat cleaning system of claim 10, wherein the at least one spray mechanism is a motorized spray assembly positioned within the enclosure and configured for automatically washing the at least one floor mat suspended within the enclosure.

13. The floor mat cleaning system of claim 12, wherein the spray assembly comprises:
a pair of substantially vertically oriented tracks mounted to the opposing side walls of the enclosure;
an at least one nozzle array configured for riding on the tracks and having an at least one spray nozzle in fluid communication with the pump; and
an at least one motor positioned and configured for automatically moving the at least one nozzle array along the tracks.

14. The floor mat cleaning system of claim 10, wherein the at least one spray mechanism is an at least one spray nozzle statically mounted within the enclosure.

15. The floor mat cleaning system of claim 1, wherein the basin provides an at least one drain hole configured for selectively draining the contents of the basin.

16. The floor mat cleaning system of claim 1, further comprising an at least one filter positioned a distance above the floor panel and configured filtering debris that falls into the basin.

17. The floor mat cleaning system of claim 16, wherein the filter is configured as a drawer that is slidably engaged with the enclosure.

18. The floor mat cleaning system of claim 1, wherein the basin provides a grease trap for collecting any grease or oil that might fall from the at least one suspended floor mat while it is being cleaned.

19. A floor mat cleaning system configured for cleaning an at least one floor mat, the system comprising:
an enclosure sized for receiving the at least one floor mat therewithin, the enclosure providing a ceiling panel, a floor panel, a pair of opposing side walls, a rear wall and an opposing front wall;
the front wall defining an opening that allows access into the enclosure;
an at least one elongate suspension bar mounted proximal to the ceiling panel of the enclosure;
an at least one elongate mat hanger configured for removably supporting the at least one floor mat, the at least one mat hanger capable of being removably engaged with the at least one suspension bar, thereby allowing the at least one floor mat to be selectively suspended within the enclosure;
a washing assembly engaged with the enclosure and configured for cleaning the at least one floor mat suspended within the enclosure; and
the floor panel, front wall, rear wall and side walls cooperating to define a basin within the enclosure, the basin configured for catching and retaining any debris or substances that might fall from the at least one suspended floor mat while it is being cleaned;
whereby, during use, the system allows the at least one floor mat to be cleaned and subsequently hanged dry in a self-contained area, without having to move the at least one floor mat during the process.

20. A floor mat cleaning system configured for cleaning an at least one floor mat, the system comprising:
an enclosure sized for receiving the at least one floor mat therewithin, the enclosure providing a ceiling panel, a floor panel, a pair of opposing side walls, a rear wall and an opposing front wall;
the front wall defining an opening that allows access into the enclosure;
a suspension mechanism positioned within the enclosure and configured for allowing the at least one floor mat to be selectively suspended within the enclosure;
a pump positioned within a housing that is secured to the enclosure;
a water inlet connector in fluid communication with the pump and configured for allowing the pump to be selectively connected to an external water source;
an at least one spray mechanism in fluid communication with the pump and configured for selectively spraying the at least one floor mat suspended within the enclosure; and
the floor panel, front wall, rear wall and side walls cooperating to define a basin within the enclosure, the basin configured for catching and retaining any debris or substances that might fall from the at least one suspended floor mat while it is being cleaned;
whereby, during use, the system allows the at least one floor mat to be cleaned and subsequently hanged dry in a self-contained area, without having to move the at least one floor mat during the process.
